(19) United States
(12) Patent Application Publication
(10) Pub. No.: US 2018/0285924 A1
(43) Pub. Date: Oct. 4, 2018

(54) Eyeball aware Geo relevant advertisements for 360 images and video

(71) Applicant: Christopher Carmichael, Irvine, CA (US)

(72) Inventor: Christopher Carmichael, Irvine, CA (US)

(21) Appl. No.: 15/939,554

(22) Filed: Mar. 29, 2018

Related U.S. Application Data
(60) Provisional application No. 62/478,142, filed on Mar. 29, 2017.

(51) Int. Cl. G06Q 30/02; G06T 7/70; G06F 3/01; H04W 4/021; H04N 13/189

(52) U.S. Cl. CPC G06Q 30/0244; G06T 7/70; H04N 13/189; H04W 4/021; G06F 3/013

(57) ABSTRACT

An image is evaluated to determine locations in the image that have more contextually relevant objects. This is done by monitoring the eyeball location of a number of different people who look at the image. The image can be for example 360 image, or can just be an image with a number of different objects in it. The parts of the image which are more contextually relevant become areas where advertisements will be located. The advertisements can be located associated with the content of the contextually relevant part of the image, or unassociated with that part, for example in associated with the geo-fenced location of the image. The most contextually relevant parts of the image can also be surrounded with a perimeter, preventing the advertisement from being displayed within the perimeter, and thus maintaining the high relevance of the highly relevant areas in the image.

This application claims priority from provisional application No. 62/478,142, filed Mar. 29, 2017; the entire contents of which are herewith incorporated by reference.

### BACKGROUND

One way of monetizing actions on the Internet is through advertisements. Advertisements which are more relevant may get more clicks and make more money for the advertiser who is hosting the ads, as well as for the company making the advertisement.

### SUMMARY

The present invention describes a technique of providing relevant advertisements associated with 360° images or video. Embodiments tracking finding “eyeball data” about where users are looking, and using that along with location to determine relevant ads and placement of the ads in the 360 environment.

### BRIEF DESCRIPTION OF THE DRAWINGS

FIG. 1 shows a basic system of obtaining a 360 image or video;

FIG. 2 shows a flowchart which is run by a processor; and

FIG. 3 shows how advertisements can be added to the images.

### DETAILED DESCRIPTION

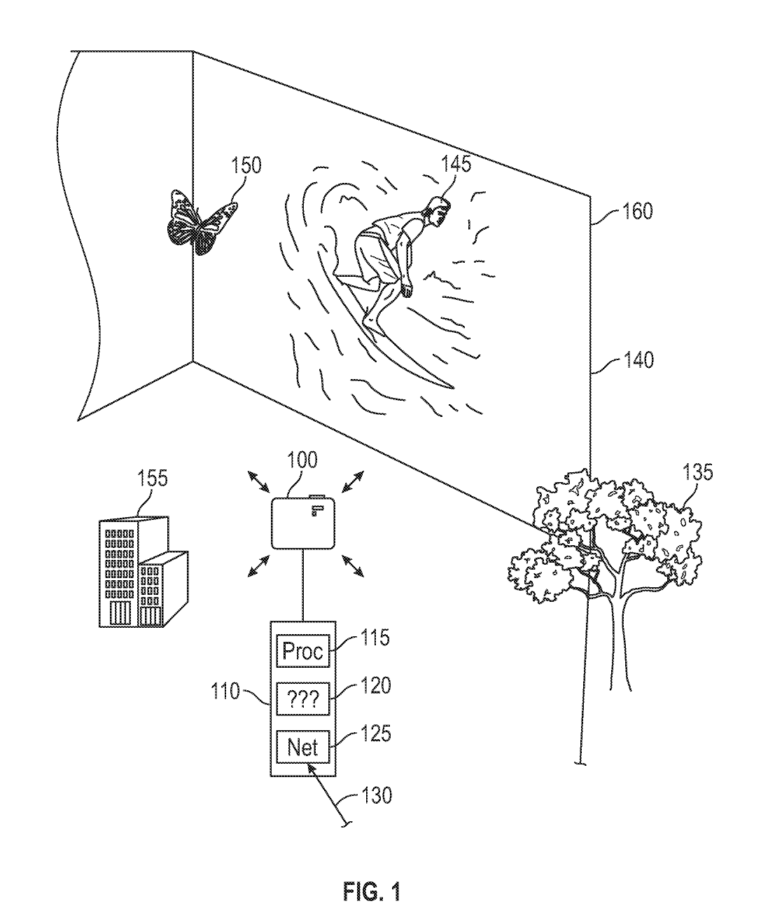

FIG. 1 illustrates an exemplary creation of 360° content as well as an example of the content itself. As described herein, the 360° content can be an image, or a video, where the image can be a frame of the video representing a single moment in time of the video, or can be any other kind of content where user can view the content in any of a number of different viewpoints. In one embodiment, the content can be viewed around 360°. Because the content is viewed in 360°, users view the content by positioning their heads or positioning their viewing client in a direction order to view different points of view associated with the content.

In FIG. 1, a 360° camera 100 is used to obtain 360° information. While the description herein provides 360°, it should be understood that the content may be somewhat less than 360°, for example the user may obtain content only for a circle around the camera, and not a full sphere around the camera. As shown, the camera 100 obtains information from a number of increments of 360° around the camera. The camera may do this all at once by using lenses located around the camera, or may require the user to turn around and take a panorama of the different parts of the scene. The camera 100 may have inserted therein various processing equipment, and or may be associated with processing equipment and an external processor, e.g., a cellular phone or a processing structure.

The processing structure 110 may include a processor 115, a location module 120 which include a Bluetooth module, may be a wireless detection module, using GPS or any other kind of location sensitive device, and a network attachment 125 which sends and receives the information to a network. In operation, the user obtains image information or video information which is uploaded as 130 to the network.

As shown in FIG. 1, the information may have different parts. A user standing in the location of the camera 110 may receive information about different things such as the plants 135, the ocean 140 which shows a surfer 145 and ocean wildlife 150, as well as buildings 155 which here is shown as a beach hotel. Of course, there may be many different items in the image, and the image extends all the way around the camera, so different things may be in different locations around the image.

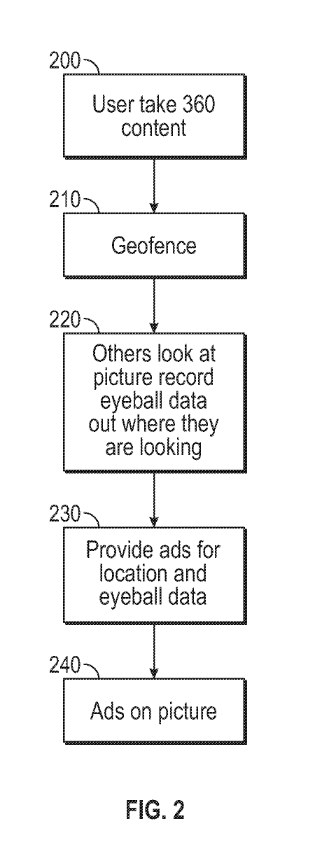

The processor 115 may be either inside the camera or associated with the camera via a wireless connection or both. The processor 115 operates according to the flowchart of FIG. 2.

At 200, the user obtains 360° content. The content can be content as described above.

At 210 the location of the content is detected, or ‘geofenced’. This can be done using the location module 120, or can be otherwise ascertained using information from the processing device 110, e.g., using metatags in the content itself or using clues in the image to determine its location.

The image (or video) is then posted, and others are allowed to view the picture. During the viewing the image, the system records “eyeball data” about where the users are looking at 220. This can be from head position in a VR device, or if viewed on a screen, can be cursor position, or if viewed on a phone, can be the position of the image that is shown on the screen.

For example, the eyeball data when users are viewing FIG. 1 may be metadata indicating that 80% of the users are looking at the surfer 145 and 20% of the users are looking at the garden 135 at any given time. The geo-fencing information, moreover, tells the system what is around or close to the location of the picture.

At 230, ads are provided that are relevant for the location data and the eyeball data, or just for the location data. For example, in FIG. 1, ads for the beach hotel may be provided when users are looking at the hotel 155, for example advertising to ‘stay at our hotel’. Ads associated with a surfer may be provided, and/or saying ‘would you like to take surf lessons’, or ‘would you like to buy gear for this famous surfer’, when users are looking at the surfer 145.

At 240, ads are added to the picture as translucent holographic ad information that is positioned near but not covering the item being looked at.

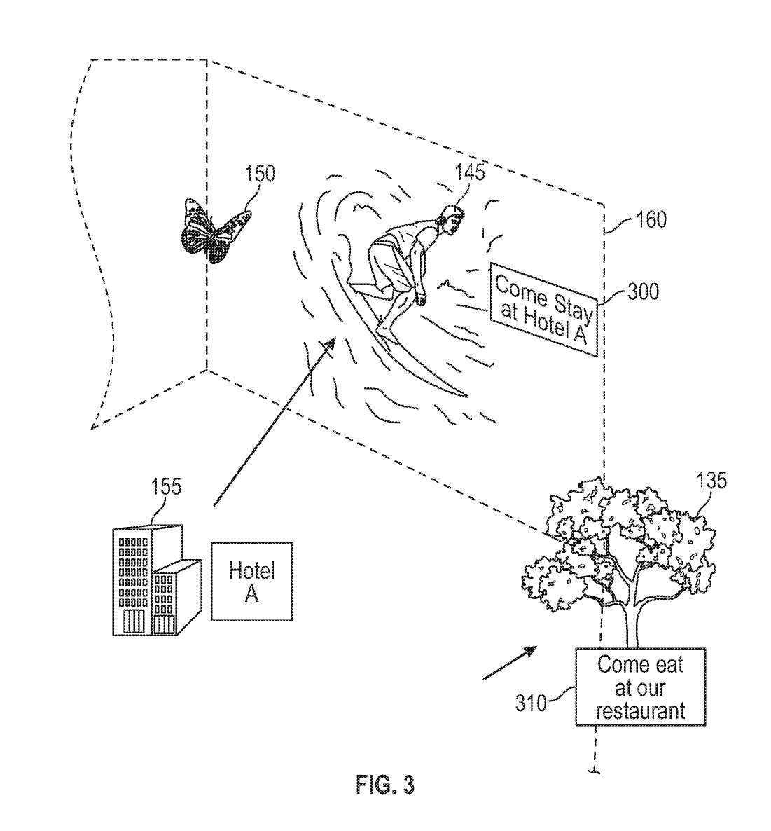

FIG. 3 illustrates how the ads may be located at areas of more concentrated viewing. In the example given above, most of the people are looking at the surfer 145. Accordingly, a high relevance semi-translucent ad 300 is located in a location near the surfer in the 360° image, but not covering any part of the surfer. This ad 300 is for hotel 155 which is the beach hotel that is in the field of view of the camera 100.

Other people are looking in the direction of the garden 135, so a second ad 310, which will be less contextually relevant, is added to the area of the garden 135. This ad is for a restaurant in the area of the camera. The restaurant may be further from the camera and may not even be in the field of the camera, but is close enough to the position of the camera to make it a relevant advertisement.

In this way, users are still allowed to look at the items that they want to look at, but receive geographically relevant ads for those items, the ads being located in the image at locations which are relevant to the eyeball data. The ads do not cover any part of the relevant eyeball targets.

In one embodiment, the specific location of the relevant eyeball target is outlined with a perimeter shown as 160 in FIG. 1. This perimeter is based on the specific eyeball tracking location obtained from different positions of viewing the information, e.g., positions users' heads who are looking at that information.

The perimeter 160 is then used as a location within which the ad cannot be located. As shown in FIG. 3, the ad 300 is located just outside the perimeter 160, as close to the perimeter as possible, but not blocking any part of the viewing.

This system thus obtains three different kinds of information. A first kind of information is information about the location at which the picture is being taken. Establishments that might want to advertise which are physically near that location, whether they are in the field of view of the picture or not.

A second kind of information is eyeball information, in essence the area of the image that the users find most relevant when they look at the picture, as measured by determining which portions of the picture get looked at most often by users who are looking at the image. These most relevant areas are used to set the relevance of the ads which are shown in these areas. For example, a user may pay more to advertise in a more relevant location in the picture.

A third kind of information is perimeter information, setting an area of the image which users find to be most appealing so that area of the image is not blocked by advertisements of any kind.

In this way, the most contextually relevant possible ad can be created associated with the images, without making the images less relevant by blocking any part of the image.

Although only a few embodiments have been disclosed in detail above, other embodiments are possible and the inventors intend these to be encompassed within this specification. The specification describes specific examples to accomplish a more general goal that may be accomplished in another way. This disclosure is intended to be exemplary, and the claims are intended to cover any modification or alternative which might be predictable to a person having ordinary skill in the art. For example while the above describes only certain kinds of user interface devices, it should be understood that other kinds of devices may similarly be used. Also, this refers to images, but it should be understood that this can similarly be applied to videos, and the information about the images referring only to one specific moment in the image.

Any kind of processor or client can be used with this invention.

What is claimed is:

1. A system of advertising, comprising:
a processing system, receiving an image which has a number of different parts therein, and receiving data about the image which represents an eyeball location for each of a plurality of different views of the image, where the eyeball location indicates which of the different parts of the image is being viewed;
said processing system determining areas of highest relevance in the image, based on determining which of the plurality of which of the areas have the most occurrences of eyeball location,
said processing system receiving advertisements, and placing the advertisements in areas of the image, relative to the parts which have the most occurrences of eyeball location.

2. The system as in claim 1, wherein the processing system determines areas in the image which have the most occurrences of eyeball location, creates a perimeter around the areas in the image which have the most occurrence of eyeball location, and places the advertisements outside the perimeter to avoid blocking the areas which have the most occurrence of eyeball location.

3. The system as in claim 1, wherein the processing system geofences the image to determine a location of the image, and where the advertisements are received comprise advertisements which are relevant to the location of the image.

4. The system as in claim 3, wherein the advertisements that are received are also relevant to items that are in the image.

5. The system as in claim 1, further comprising a 360° camera, obtaining a 360° view of the image.

6. The system as in claim 5, wherein the image has multiple different discrete objects therein as the multiple different parts, and at least a plurality of the discrete objects is associated with an advertisement that is relevant to the discrete objects.

7. The system as in claim 1, wherein the advertisement is displayed on the image as translucent advertisements.

8. The system as in claim 8, wherein the processor determines a percentage breakdown of an amount of time that people spend looking at any different part in the image, and the processor defines areas which receive more viewing as being more contextually relevant, and areas that receive less viewing as being less contextually relevant, and where a perimeter is defined around items which are more contextually element within which an advertisement cannot be located.

9. The system as in claim 8, wherein the advertisement is located close to the perimeter, and is related to a content of what is inside the perimeter.

10. The system as in claim 8, wherein the advertisement is located close to the perimeter, and is related to an advertising subject that is located close to a location of the image, but not seen in the image.

11. The system as in claim 1, wherein the image has multiple points of view, and the relevance is determined based on which of the multiple points of view are selected.

12. The system as in claim 1, wherein the image is a 360° image, and the relevance is determined based of on the point of view which is selected.

13. A method of advertising on a computer, comprising:
receiving an image which has a number of different parts therein;
receiving data about the image which represents an eyeball location for each of a plurality of different views of the image, where the eyeball location indicates which of the different parts of the image is being viewed;
determining areas of highest relevance in the image, based on determining which of the plurality of which of the areas have the most occurrences of eyeball location, and
receiving advertisements, and placing the advertisements in areas of the image, relative to the parts which have the most occurrences of eyeball location and displaying the image with advertisements to users.

14. The method as in claim 13, further comprising determining areas in the image which have the most occurrences of eyeball location, creating a perimeter around the areas in the image which have the most occurrence of eyeball location, and placing the advertisements outside the perimeter to avoid blocking the areas which have the most occurrence of eyeball location.

15. The method as in claim 13, further comprising geofencing the image to determine a location of the image, and where the advertisements are received comprise advertisements which are relevant to the location of the image.

16. The method as in claim 15, wherein the advertisements that are received are also relevant to items that are in the image.

17. The method as in claim 15, wherein the image has multiple different discrete objects therein as the multiple different parts, and at least a plurality of the discrete objects is associated with an advertisement that is relevant to the discrete objects.

18. The method as in claim 13, wherein the advertisement is displayed on the image as translucent advertisements.

19. The method as in claim 18, wherein the processor determines a percentage breakdown of an amount of time that people spend looking at any different part in the image, and the processor defines areas which receive more viewing as being more contextually relevant, and areas that receive less viewing as being less contextually relevant, and where a perimeter is defined around items which are more contextually element within which an advertisement cannot be located.

20. The method as in claim 18, wherein the advertisement is located close to the perimeter, and is related to a content of what is inside the perimeter.
